(19) United States
(12) Patent Application Publication
(10) Pub. No.: US 2004/0026415 A1
(43) Pub. Date: Feb. 12, 2004

(54) Microwave oven for heating and/or cooking foodstuffs which have been deep-frozen and/or frozen and /or iced and/or thermally reduced, by carrying out a temperature increase of more than 80 degrees centigrade in a few seconds

(75) Inventors: Mirko Piasentin, Colle Umberto (IT); Alessandro Sonego, Sacile (IT); Giorgio Da Ros, Sarmede (IT); Guislaine Freda, Treviso (IT); Remo Ruspini, Quito di Treviso (IT); Samuele Salamon, Anzano di Cappella Maggiore (IT)

Correspondence Address: John S. Egbert, Harrison & Egbert, 7th Floor, 412 Main Street, Houston, TX, 77002, US

(73) Assignee: CIBOTIKA SRL, Spresiano (IT)

(21) Appl. No.: 10/385,322

(22) Filed: Mar. 10, 2003

(30) Foreign Application Priority Data
Aug. 8, 2002 (IT) TV2002A000094

(51) Int. Cl. H05B 6/64; H05B 6/80

(52) U.S. Cl. 219/680; 219/731

(57) ABSTRACT

Microwave oven unit for foodstuffs, made up of at least one upper fixed part and at least one mobile lower part which includes at least one radio frequency source for heating at least one thermostat-controlled environment by electromagnetic waves, for the contact heating of the surfaces of food containers and/or trays which are loaded inside and, therefore, through transmission, of the surface of the portions of food contained inside, with the unit commanded and controlled by at least one logic control unit.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The object of this invention is a microwave oven for heating and cooking portions of food which have been deep-frozen and/or frozen and/or iced or thermally reduced in some way below 0° C., and which is able to carry out a temperature increase of more than 80° C. in less than 90 seconds, resulting in a portion of food which is homogenously heated or cooked.

The innovation may be applied particularly in the sector of domestic and automated catering.

### BACKGROUND OF THE INVENTION

The application of electromagnetic waves with a very short wave length, commonly known as microwaves, is a system which has been applied for a long time for both industrial and domestic heating and cooking.

Electromagnetic radiation takes place when an electric current passes through a conductor, for example copper wire, and when the movement of the electrons through the said wire produces an energy field around the wire which fluctuates slightly above its surface. This fluctuation zone or energy cloud is made up of two distinctive energy fields, electric and magnetic, which are the cause of the two dielectric mechanisms: ionic polarization and dipole rotation.

Ionic polarization occurs when the ions which are present in material are caused to move by an electric field. The ions are electrically charged and receive kinetic energy from the field, and this energy is converted into heat when the ions collide with each other, thus determining an increase in the temperature inside the material.

Dipole rotation depends on the existence of polar molecules, which are randomly orientated. However, when there is an electrical field, the molecules line up according to the field. Since the field oscillates and its polarity varies according to the frequency, the molecules tend to follow the oscillation of the field, provoking high friction between each other leading to an increase in temperature inside the material.

The combination of the electrical and magnetic waves gives rise to the electromagnetic waves which travel al right angles, with respect to a straight line, towards each other and in the direction of the movement.

Microwaves are transversal waves.

The microwaves applied to industrial and domestic ovens for heating and cooking foodstuffs have a low frequency with reduced energy, around 2450 MHz, are “non-ionizing” and have enough power to provoke vibrations which then cause molecular friction which produces heat for heating up and cooking the foodstuffs.

The microwaves pass through a wide range of materials which absorb them, amongst which mainly foodstuffs.

The cyclical, “wavy” movement with respect to a straight line is made up of positive and negative half-waves, and acts as a magnet which, by moving backwards and forwards, cyclically changes the polarization.

As the positive half-waves of the microwaves penetrate in the food, the negative particles of the molecules are attracted and try to orient themselves with the field of attraction. Then, when the half-waves change polarity, the exact opposite occurs; the negative particles are repelled while the positive particles are attracted, causing an agitated movement and, therefore, the phenomenon of molecular friction leading to heating.

The agitated movement reaction of the particles inside the molecules with the frequency currently used for microwave ovens is 2450 million cycles per second and, considering the fact that in each cycle the molecules change direction twice (once for the positive half-cycle and once for the negative half-cycle), vibration or rotation is caused which provokes enormous friction between the molecules of water and the ions contained in the material.

And it is precisely this friction which produces the heat.

In this way, the heat is produced directly in the food, even if the food is not cooked from the inside towards the outside as is commonly believed. As a matter of fact, the food starts to cook just below the outside surface and continues towards the inside and the outside, with most of the energy being used up in the inner layers.

The amount and type of cooking depends on the thickness and density of the food, and on its capacity to conduct heat.

The conductive capacity is directly proportional to the quantity of water molecules which are present in the foodstuff to be heated up or cooked. Therefore, the richer it is in water molecules the quicker it reaches the required heating or cooking temperature. In fact, water is one of the best known dipolar molecular complexes, and is extremely receptive to the electromagnetic field inversions and involves the effect of both ionic polarization and dipolar rotation.

In the case of foodstuffs which have been deep frozen and/or frozen and/or iced and/or thermally reduced, that is, conserved at a low temperature, the cooking starts only once the first part of the ice has started starts to melt.

The dielectric reaction time of ice is 70% higher than that of water. In fact, a water molecule in the solid state has a high resistance in following the inversion of the electromagnetic field to which it is subjected, compared with when the same molecule is in the liquid state.

Basically, in a molecule of water in the solid state, there is a lack of mobility of the ion charges which are dissolved and present in the liquid state.

Even though microwave ovens represent the quickest way to heat up and cook foodstuffs, there is a strong need for a heating and/or cooking process which is far quicker than those carried out by domestic, industrial or professional microwave ovens currently available on the market.

Industrial microwave ovens overcome the speed problem by using a “running belt” system, continuously loading the food to be cooked one after another on a conveyor belt which passes through a long resonance chamber, thus heating up and/or cooking a number of portions in the same period of time, or by increasing the radiant power of the oven by applying a number of magnetrons or a magnetron with a high Kw value.

These solutions, however, which are applied to foodstuffs which have been deep-frozen and/or frozen and/or iced and/or thermally reduced, and in all cases where they are conserved at a low temperature, that is, below 0° C., do not guarantee that the heating or cooking is homogenous.

### BRIEF SUMMARY OF THE INVENTION

The aim of the invention described below, is to create an oven unit which, in a few seconds, homogenously heats up and cooks foodstuffs which have been deep-frozen and/or frozen and/or iced and/or thermally reduced, and in all cases where they have been conserved at a low temperature, and whose water content is in a solid state (ice); foodstuffs, therefore, conserved at low and very low temperatures which, without being thawed out before being heated up, are put directly into the heating unit.

In particular, the invention claims to carry out an increase in temperature of more than 80° C. in the space of a few seconds.

The aim and advantage of this invention is to manufacture a microwave oven which combines a heating and cooking system based on a Radio Frequency source with a thermostatically-controlled environment, that is, heated up and kept at a constant temperature.

The said environment may be the same resonance chamber in the microwave oven heated up by a direct source such as a heating element and/or an infrared light source or similar device, or a structure which is specially shaped in the upper part in order to house the trays or containers of foodstuffs, with an internal part to house a conductor which is heated up and kept at a constant temperature, which heats up the surfaces of the containers which are located inside due to them being in direct contact and, by heat transmission, the surfaces of the foodstuffs contained in them.

The aim and advantage which derives from the combination of a Radio Frequency source with a thermostatically-controlled environment, is to encourage the melting of the first layer of ice in the portion of food and the formation of molecules of water, quickly starting up the friction process between the molecules of the portion of food provoked by the Radio Frequency source; to start up the heating process of the surfaces of the portion of food directly opposite the radiant source and recovering the disadvantage in normal microwave ovens where only the upper surface is heated up, heating up and/or cooking more quickly, therefore, to the detriment of lateral and/or lower surfaces and, therefore, the homogeneity of the result of the heating up and/or cooking process; to obtain a process with repeatable heating or cooking characteristics of the food, being carried out in an environment in which the thermal values are fixed and made invariable.

The advantage which derives from this system is that there is a very large reduction in the time required for heating up which, especially in the catering industry, represents a possibility in reducing the time required to heat up even portions of food which have been pre-cooked and frozen for conservation purposes, or for not having to thaw out large quantities of food when a high request for them is foreseen, with the risk that they are not consumed and have to be thrown away.

Furthermore, it is possible to eat meals which have been conserved by using the various freezing techniques available and which offer superior conditions of hygiene and far longer storage times than with fresh food or food which is conserved in a modified atmosphere, and the total absence of preservatives, thickeners and various additives which, apart from altering the real genuineness of the product which is to be conserved, certainly change the naturalness of its composition.

It may be safely said, therefore, that the advantage of the invention described below is that it is possible to take a portion of food from the freezer and, without thawing it out, put it directly into the oven and take it out after approximately sixty seconds, perfectly and homogeneously heated up and/or cooked.

These and other advantages will be shown in the following detailed description and attached drawings of at least one preferential application of the solution, the details of which are intended to be an example and not a limitation.

### BRIEF DESCRIPTION OF THE SEVERAL VIEWS OF THE DRAWINGS

FIG. 1 is a side assembly view of the inside of the oven used, according to a section which is parallel to the vertical rotation axis.

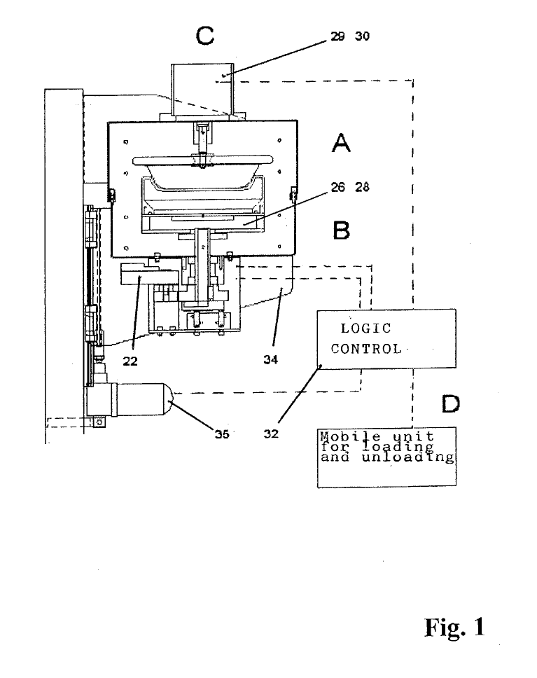

FIG. 2 is a side view of the upper fixed part (A) and the lower mobile part (B) according to a section which is parallel to the vertical rotation axis.

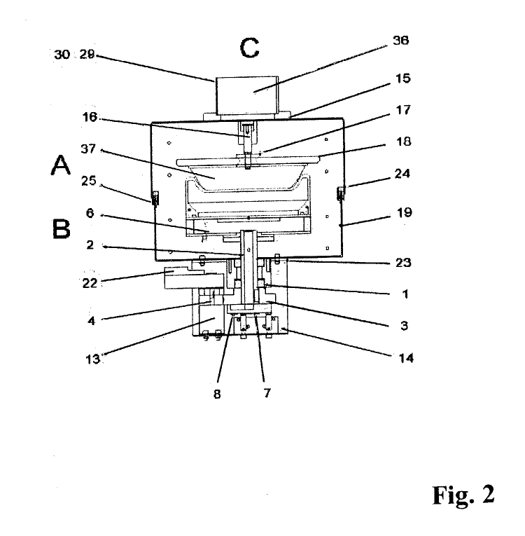

FIG. 3 is a front view of the upper fixed part (A) and the lower mobile part (B) according to a section which is parallel to the vertical rotation axis.

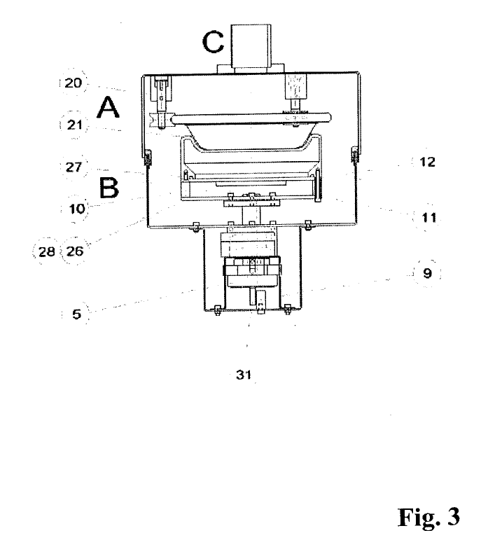

FIG. 4 is a plan view of the upper fixed part (A).

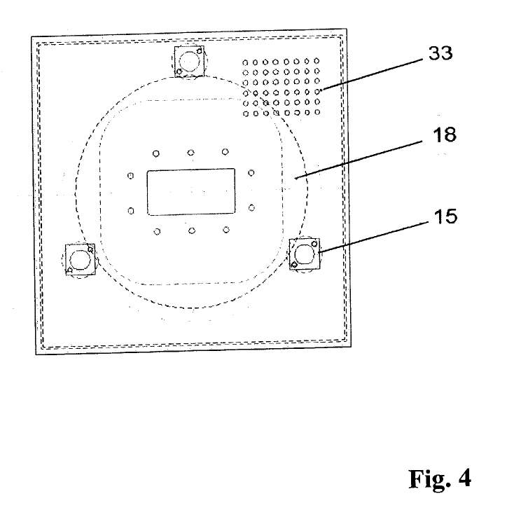

### DETAILED DESCRIPTION OF THE INVENTION

The oven which is the object of this application is characterized by the fact that it includes an upper fixed part (A), a lower mobile part (B), at least one cavity for housing the trays or containers of food, at least one radiant unit (C), at least one contact-heating unit (21), at least one logic control unit (32) and at least one mobile unit for loading and unloading (D) the containers of food.

The upper fixed part (A) is made up of a fixed oven plate (20) on which the radiant unit (C) is mounted, and which includes at least one radio frequency heating unit (29) which gives off electromagnetic waves directly into the oven by means of at least one metallic channel (30) which acts as a wave guide (30), and a sealing ring (18) which presses on the cover of the tray of food to avoid it being deformed due to the increase in temperature and the formation of steam.

The said fixed oven plate (20) forms a resonance cavity (36).

The said metallic channel acts as a wave guide (30) in order to channel and diffuse the electromagnetic waves produced by the said radiant unit (C) in the said resonance cavity (36).

The said sealing ring (18), made out of material which is transparent and/or semi-transparent to the radio waves, is supported by small roller wheels (17), each of which may be held and made to turn by a roller pin (16) which is fixed to the pin-holder plate (15) which forms the upper wall of the fixed part (A) and in which there are a number of holes (33) in order to let out the steam formed inside the oven.

The lower mobile lower part is made up of a mobile oven plate (19) to which at least one food-tray cradle (21) subject to contact heating is fastened.

The said cradle (21) is used to house the food tray (37) in which the food to be cooked is contained, and which is moved and loaded in the said cradle (21) and removed from the said cradle (21) by a mobile loading unit (D).

The said cradle (21) is hollowed out in the lower part to hold diathermic oil and has a cavity where a holding gasket is fixed (27) and is closed by means of a closure ring (12), with a heating element (26) fixed to the lower part for heating the oil, and a thermostat (28) which controls the temperature and keeps it constant.

The said thermostat (28) is directly connected to a logic control unit (32).

The upper part of the contact-heated food-tray cradle (21) is shaped in order to hold at least one food tray and heat it up by contact.

In order to connect the said closure ring (12) to a lower ring (11) and leave enough space to house the heating element (26), a spacer ring (10) is inserted which also acts as a protection for the said heating element (26) and its relative electric cables by insulating them against electromagnetic radiation.

The said lower ring (11) is also fixed to the shaft of a motor (2), and between the two devices there is an insulating ring (6) which acts as a thermal insulator to avoid the dispersion of heat between the said lower ring (11) and the said shaft of the motor (2).

The said shaft (2) has a hole in the central part where the electrical cables for the heating element (26) are passed, and is supported by bearings (23) which are mounted on a bearing support (1).

Attached to the lower part of the said shaft (2), there is a cog (3) which is driven by a gearbox (22) by means of a drive cog (4).

The said gearbox (22) carries out the rotation of the food-tray cradle (21) during the radio-frequency heating process, in order to guarantee that the contents of the food tray are heated homogenously.

The said gearbox (22) is controlled by a logic control unit (32), and is mounted on a motor support (13) fixed on a lower support (14).

A lower insulation ring (5) made out of insulating material is fixed to the said cogwheel (3), and holds a central ring (7) and an external ring (8) which receive the electrical current from the tips (31) mounted on a contact support (9).

The said contact support (9) is fixed on a lower support (14) in order to connect the heating element (26), located on a rotating part, to the fixed electrical current feeder.

The lower mobile part (B) is mounted on at least one carriage (34) and is moved vertically by at least one electric linear actuator (35).

In the contact and closure part between the upper fixed part (A) and the lower mobile part (B), and more precisely in the resonance cavity (36) formed inside the fixed oven plate (20), there are gaskets which are fitted on the inside (32) and around the edges (25) to avoid the leakage and dispersion of microwaves in the said contact area.

The whole operation of the oven which is the object of this application, is controlled by at least one logic control unit (32) according to a certain software program.

The said logic control unit (32) establishes the operation of each single device which carries out at least one movement of at least one of the components in the oven, the switching-on of the radiant unit (C) and the operation of the mobile loading and unloading unit (D) of the food tray (37).

The said logic control unit (32) controls the type and length of time for heating the food trays or containers (37), by means of combined heating between the microwaves given off by the radiant unit (C) and the food-tray cradle (21) which is subject to contact heating, according to a pre-set program which determines the type and length of time for heating for each single recipe and according to the data inserted through the control panel, which is part of the electronic circuit of the said logic control unit (32).

The said logic control unit (32) controls the whole heating and/or cooking process, from the loading of the food tray (37) which contains the portion of frozen food into the special food-tray cradle (21) pre-heated with diathermic oil, by means of at least one mobile loading and unloading device (D) which is part of the mobile lower part (B).

Once the said mobile part (B), controlled by a logic control unit (32), has loaded the said portion of food (37) in the food-tray cradle (21), it lifts up and closes against the upper fixed part (A), moved by an electric linear actuator (35) and by sliding along a support carriage (34) on the lower mobile part (B).

A tight seal is formed by means of gaskets on the inside of the cavity (24) and around the edges (25), to prevent leakage of electromagnetic waves.

The heat given off by the said tray cradle (21) propagates through the walls of the food tray (37), heats up the surface of the portion of food due to it being in contact, and melts the first layer of ice to form molecules of water which are strongly agitated by the electromagnetic waves given off by at least one radiant unit (C) which is controlled by a logic control unit (32), and introduced and diffused by means of at least one wave guide (30) in the resonance cavity (36) formed in the fixed oven plate (20) of the upper fixed part (A) of the oven, and the friction with the ions contained in the food causes the strong heat which provokes the immediate heating-up of the portion of food.

The cooking phase is controlled by a logic control unit (32) according to a pre-set program which determines the time of exposure to the electromagnetic waves for each single recipe and according to the data inserted on the control panel which is part of the electronic circuit of the logic control unit (32).

The said logic control unit (32) also controls the rotation of the lower ring (11) according to the commands of the pre-set program, to guarantee that the heating of the portion of food is homogenous.

Finally, once the portion of food has been heated up and/or cooked according to a pre-set program which determines the time each different recipe is exposed to the electromagnetic waves, the said logic control unit (32) commands the end of the emission of the electromagnetic waves from at least one radiant unit (C) and the reopening of the mobile lower part (B) by sliding it vertically, with its movement controlled by an electric linear actuator (35) which makes the mobile part B slide along a support carriage (34).

The said logic control unit (32) then commands the removal of the food tray (37) from the tray cradle (21) and the unloading movement by means of at least one mobile unit for loading and unloading (D).

It has thus been demonstrated how this invention considerably reduces the time required for heating up and/or cooking frozen foods, in order to increase the distribution rate of portions of food which were previously frozen and then cooked and/or heated up to order, and which may be loaded in a continuous cycle and with dedicated, differentiated programs.

Above all, this invention allows the catering sector to serve portions of food which are fresh and without having to thaw out quantities which are superior to the successive request.

What is more, especially in the catering sector, this invention means that even more frozen foods may be processed rather than foods treated with preservatives and/or thickeners which are used in order to avoid foodstuffs deteriorating and/or going off.

The dimensions, materials and power of each single component described above are obviously not intended to be limiting, but are purely examples and may be of any type according each specific application.

We claim:

1. Oven unit which is dedicated particularly to heating up and/or cooking portions of food previously deep-frozen and/or frozen and/or iced and/or thermally reduced below a temperature of 0° C. with IQF and/or similar and/or analogous systems, characterized by the fact that at least one radiant unit (C) for heating by means of electromagnetic waves (microwaves) is associated with a thermostat-control led environment, that is, heated up and kept at a constant temperature, being formed by a contact-heating system made up of a tray cradle (21) which is preheated and kept at a constant temperature, to guarantee the transmission of heat from the said cradle (21) to the surfaces of the food trays or food holders (37) which come into contact with it and, therefore, also for transmission, to the surfaces of the food, thermally reduced to a temperature below 0° C., which is contained in the said food trays or containers (37), causing the first surface layer of ice to melt and the formation of the first molecules of water to accelerate the phenomenon of molecular friction due to the action of R.F. radiation, thus setting under way the process of heating up and/or cooking.

2. Unit as described in claim 1, characterized by the fact that the upper part of the said tray cradle (21) is shaped in order to contain the food tray (37) and heat it up due to it being in contact.

3. Unit as described in claims 1 and 2, characterized by the fact that the said tray cradle (21) is hollowed out in the lower part to contain diathermic oil or some other element radiated by at least one heating element (26) and/or by at least one infrared source and/or by at least direct heat source and/or similar and/or analogous element, which operates by thermal conduction.

4. Unit as described in claims 1 to 3, characterized by the fact that the said diathermic oil or other radiated element is kept at a constant temperature by at least one thermostat (28).

5. Unit as described in claims 1 to 4, characterized by the fact that the said heating due to contact provokes the melting of the surface layer of ice in the portion of frozen food contained in the food tray (37) to form the first molecules of water which immediately start up the friction process, characterizing the speed of heating and cooking by means of radio frequency processes, thus accelerating the process and the time required.

6. Unit as described in claims 1 to 5, characterized by the fact that the portions of frozen food contained in the food trays or containers (37) are loaded into the tray cradle (21) and then removed by at least one mobile loading and unloading unit (D).

7. Unit as described in claims 1 to 6, characterized by the fact that the said oven includes a fixed upper part (A) and a lower mobile part (B) which is moved vertically by an electric linear actuator (35) and is mounted on a support carriage (34) to allow at least one food tray (37) to be loaded and removed by means of a mobile loading and unloading unit (D).

8. Unit as described in claims 1 to 7, characterized by the fact that the said fixed upper part (A), open in the bottom, and its fixed oven plate (20) form at least one resonance cavity (36) into which the electromagnetic waves generated by at least one radiant unit (C) are transmitted and diffused by means of at least one wave guide (30).

9. Unit as described in claims 1 to 8, characterized by the fact that the said fixed upper part (A) includes at least one sealing ring (18) on the inside, which presses against the cover of the food tray (37) to avoid it deforming and/or opening and/or any other form of giving around the edges due to the increase in temperature and the formation of steam.

10. Unit as described in claims 1 to 8, characterized by the fact that the said sealing ring (18) may be a rigid plate and/or an air cushion and/or a membrane and/or a ring covered by cloth and/or similar and/or analogous material, and is made out of material which is transparent or semi-trans parent to radio waves, having the R.F. radiation absorption level much lower to that of the foodstuffs subjected to the heating and/or cooking process, such as with silicone and/or silicone-glass fibre and/or Kevlar fibre and/or Teflon and/or PTE and/or PTFE and/or similar and/analogous materials.

11. Unit as described in claims 1 to 9, characterized by the fact that the said sealing ring (18) is supported by small rollers (17), each of which may be held and made to roll by at least one roller pin (16) fixed to the pin-holder plate (15) mounted on the internal upper wall of the upper fixed part (A).

12. Unit as described in claims 1 to 10, characterized by the fact that there are a number of holes (33) in the said pin-holder plate (15) in order to let out the steam formed inside upper fixed part (A) during the heating and/or cooking process.

13. Unit as described in claims 1 to 11, characterized by the fact that the said unit includes at least one mobile lower part (B) mounted on at least one support carriage (34) and is moved vertically and/or horizontally by at least one electric linear actuator (35).

14. Unit as described in claims 1 to 12, characterized by the fact that the radiant unit (C) is controlled by at least one electronic circuit which contains at least one logic control unit (32) which controls the exposure time of the portions of frozen food contained in the food trays or containers (37) to the electromagnetic waves according to the commands of a pre-set program which determines the exposure time of each single recipe to the electromagnetic waves.

15. Unit as described in claims 1 to 13, characterized by the fact that the mobile lower part (B) is controlled by at least one electronic circuit which contains at least one logic control unit (32) which controls its vertical and/or horizontal and/or diagonal movement by means of at least one electric linear actuator (35).

16. Unit as described in claims 1 to 14, characterized by the fact that the mobile unit for loading and removing (D) the portion of frozen food contained in the food tray (37) in the tray cradle (21) is controlled by at least one electronic circuit which contains at least one logic control unit (32) which controls the moment at which it is put into motion and its movements.

17. Unit as described in claims 1 to 15, characterized by the fact that the lower ring (11) which is included in the lower mobile part (B) is controlled by at least one electronic circuit which contains at least one logic control unit (32) which controls its rotation by means of a gearbox (22) and the various steps of its relative movement according to the commands in a pre-set program which determines the type of heating and/or cooking process for each single recipe.

18. Unit as described in claims 1 to 16, characterized by the fact that the thermostat (28) fixed on the closure ring (12) of the tray cradle (21) included in the mobile lower part (B) is controlled by at least one electronic circuit which contains at least one logic control unit (32) which controls the temperature inside the said cradle (21) and keeps it constant in order to contact-heat the surface of the food tray (37) positioned inside it and, by transmission, the surface layer of ice of the portion of food contained in the said food tray (37).

19. Oven unit as described in one or more of the above claims, characterized by the description and attached drawings.
